(19) United States
(12) Patent Application Publication
(10) Pub. No.: US 2013/0224451 A1
(43) Pub. Date: Aug. 29, 2013

(54) INKJET RECORDING INK COMPOSITION AND RECORDED MATTER

(71) Applicant: Seiko Epson Corporation, (US)

(72) Inventors: Shohei Shiono, Matsumoto-shi (JP); Tsuyoshi Sano, Shiojiri-shi (JP)

(73) Assignee: SEIKO EPSON CORPORATION, Tokyo (JP)

(21) Appl. No.: 13/778,785

(22) Filed: Feb. 27, 2013

(30) Foreign Application Priority Data
Feb. 29, 2012 (JP) 2012-043937

(51) Int. Cl. C09D 11/00; B32B 5/16

(52) U.S. Cl. CPC C09D 11/38; B32B 5/16
USPC 428/207; 106/31.65

(57) ABSTRACT

An ink jet recording ink composition includes an inorganic pigment (A) having an average particle diameter (D_{A}) of equal to or more than 200 nm and an inorganic particle (B). The inorganic particle (B) is preferably a silica particle or an alumina particle.

Priority is claimed under 35 U.S.C. §119 to Japanese Application No. 2012-043937 filed on Feb. 29, 2012, is hereby incorporated by reference in its entirety.

### BACKGROUND

1. Technical Field

The present invention relates to an ink jet recording ink composition, particularly, to an ink jet recording ink composition including an inorganic pigment which is easy to settle, and recorded matter.

2. Related Art

In the related art, an ink including metal oxides such as titanium dioxide, zinc oxide, alumina or magnesium oxide and inorganic pigments such as barium sulfate or calcium carbonate which exhibits a white color has been used in various printing methods. The inorganic pigments such as titanium dioxide or zinc oxide among these compounds have been widely used, particularly, in the viewpoint of low cost.

However, since these inorganic pigments have high specific gravity, there is a problem in that a difference in the specific gravity of the inorganic pigments and a solvent is generated, and the inorganic pigments are easy to settle in an ink. When such ink is left for a long time, the inorganic pigments are settled and harden so that a state in which redispersion is difficult occurs (hereinafter, the state is referred to as “hard caking”).

In order to prevent the hard caking, for example, a technology for a coating ink that has an ink viscosity of equal to or more than 1000 mPa·s and the settling of the inorganic pigment is prevented is proposed (for example, refer to JP-A-2008-208330).

However, as described above, while the ink viscosity is increased and hard caking can be prevented, ink viscosity printable in an ink jet recording method is about 2 to 15 mPa·s so that the viscosity is not sufficient to prevent the settling of the inorganic pigment. Due to this, the settling of the inorganic pigment occurs in a short time in the ink jet recording ink and a problem of hard caking cannot be solved as of yet. Due to such circumstances, it is necessary to periodically agitate the ink jet recording ink to prevent hard caking. Therefore, to provide a promptly redispersable ink jet recording ink by simple agitation is a large problem from the viewpoint of increasing market value.

### SUMMARY

An advantage of some aspects of the invention is to provide an ink jet recording ink composition in which prompt redispersion can be carried out by simple agitation and which suppresses hard caking even when the inorganic pigment is settled.

The invention can be realized in the following forms or application examples.

### APPLICATION EXAMPLE 1

According to Application Example 1, there is provided an ink jet recording ink composition including: an inorganic pigment (A) having an average particle diameter (D_{A}) of equal to or more than 200 nm; and an inorganic particle (B).

In the ink jet recording ink composition according to Application Example 1, the inorganic particle (B) is adsorbed to at least a part of the inorganic pigment (A) and the inorganic particle (B) functions as a spacer so that a likelihood that the inorganic pigments (A) are in a direct contact can be reduced. Therefore, even when the inorganic pigment (A) is settled, hard caking can be suppressed and prompt redispersion can be carried out by simple agitation.

### APPLICATION EXAMPLE 2

In the ink jet recording ink composition according to Application Example 1, the inorganic particle (B) may be a silica particle or an alumina particle.

### APPLICATION EXAMPLE 3

In the ink jet recording ink composition according to Application Example 1 or Application Example 2, an average particle diameter (D_{B}) of the inorganic particle (B) measured using a dynamic light scattering method may be more than 25 nm and equal to or less than 200 nm.

### APPLICATION EXAMPLE 4

In the ink jet recording ink composition according to any one of Application Example 1 to Application Example 3, a settling rate calculated by Stokes' equation in the ink jet recording ink composition of the inorganic pigment (A) may be equal to or more than 2.5×10⁻⁶ (cm/s).

### APPLICATION EXAMPLE 5

In the ink jet recording ink composition according to any one of Application Example 1 to Application Example 4, a content (solid content conversion) of the inorganic pigment (A) may be equal to or more than 5% by mass and equal to or less than 15% by mass with respect to a total mass of the ink composition and a content (solid content conversion) of the inorganic particle (B) may be more than 0.5% by mass and equal to or less than 8% by mass with respect to the total mass of the ink composition.

### APPLICATION EXAMPLE 6

In the ink jet recording ink composition according to any one of Application Example 1 to Application Example 5, a ratio (D_{B}/D_{A}) of the average particle diameter (D_{B}) of the inorganic particle (B) to the average particle diameter (D_{A}) of the inorganic pigment (A) may be equal to or more than 0.05 and less than 1.0.

### APPLICATION EXAMPLE 7

In the ink jet recording ink composition according to any one of Application Example 1 to Application Example 6, the pH is more than 7 and equal to or less than 10 at 25° C.

### APPLICATION EXAMPLE 8

According to Application Example 8, there is provided recorded matter in which an image is recorded with the ink jet recording ink composition according to any one of Application Example 1 to Application Example 7.

### Description of Exemplary Embodiments

Hereinafter, suitable embodiments of the invention will be described. The embodiments which will be described below are to explain an example of the invention. In addition, the invention is not limited to the following embodiments and also includes various modification examples modified within a range of not changing the scope of the invention.

### 1. INK JET RECORDING INK COMPOSITION

An ink jet recording ink composition (hereafter, also referred to as an “ink composition”) according to an embodiment contains an inorganic pigment (A) having an average particle diameter (D_{A}) of equal to or more than 200 nm, and an inorganic particle (B). Each component included in the ink jet recording ink composition according to the embodiment will be described in detail below.

### 1.1. Inorganic Pigment (A)

The ink composition according to the embodiment contains the inorganic pigment (A). Generally, a white pigment is often an inorganic pigment. For this reason, the ink composition according to the embodiment is suitably used as a white color ink.

When the ink composition according to the embodiment is a white color ink, as for the inorganic pigment (A), for example, there may be metal oxides such as titanium dioxide, zinc oxide, alumina or magnesium oxide, barium sulfate and calcium carbonate. Among these compounds, it is preferable to use a titanium dioxide particle in which titanium dioxide is powdered from the viewpoint of excellent whiteness.

The ink composition is made as a white color ink by containing the inorganic pigment (A) as exemplified above. In the specification, the “white color ink” includes inks which are capable of recording a color called “white” in general societal terms and also includes all slightly colored whitish inks. Furthermore, inks commercially available under a trade name using any words corresponding to “white color ink and white ink” and those commonly called by a name including such words are all included in the white ink. In addition, for example, the white ink includes the inks with which the brightness (L*) and chromaticity parameters (a* and b*) fall within the ranges 70≦L*≦100, −4.5≦a*≦2, and −6≦b*≦2.5 when the ink is recorded on Epson genuine photo paper <Glossy> (manufactured by Seiko Epson Corporation) at a duty of at least equal to or more than 100% or in an amount that can sufficiently coat the surface of the photographic paper, analyzed using a Spectrolino spectrophotometer (trade name, manufactured by X-Rite Incorporated) with the following measurement conditions: light source: D50; field of view: 2°; density: DIN NB; white balance: Abs; filter: No; mode of measurement: Reflectance.

The average particle diameter (D_{A}) of the inorganic pigment (A) is equal to or more than 200 nm, preferably equal to or more than 200 nm and equal to or less than 400 nm, and more preferably equal to or more than 250 nm and equal to or less than 350 nm. Since the average particle diameter (D_{A}) of the inorganic pigment (A) is equal to or more than 200 nm, an image having a favorable whiteness can be recorded.

The average particle diameter (D_{A}) of the inorganic pigment (A) is obtained by setting the basis of an abundance ratio to a volume basis and can be measured by a particle size distribution analyzer that works on the measurement principle of a laser diffractive scattering method. As for the particle size distribution analyzer, for example, there may be a “Microtrac UPA” manufactured by NIKKISO CO., LTD.

A settling rate v of the inorganic pigment (A) which can be obtained using “Stokes' equation” represented by the following equation (1) in the ink composition is preferably equal to or more than 2.5×10⁻⁶ (cm/s) and more preferably equal to or more than 7.0×10⁻⁶ (cm/s). The settling and hard caking of the inorganic pigment (A) in which the settling rate calculated using Stokes' equation is fast easily occurs in the ink composition. However, the defect can be favorably prevented according to the invention.

v={(ρ−ρw)gR²}/(18η) (1)

In the above equation (1), v refers to a settling rate (cm/s), ρ refers to pigment density (g/cm³), ρw refers to solvent density (g/cm³), g refers to gravitational acceleration (m/s²), R refers to a pigment diameter (cm), and η refers to solvent viscosity (Pa·s). A pigment diameter can be confirmed by a transmission electron microscope.

The pigment density ρ of Pigment Blue 15:3 which is a pigment included in a color ink in the related art is 1.5 (g/cm³) and the pigment density ρ of Pigment Red 122 is about 1.4 to 1.6 (g/cm³). Therefore, the settling rate is about 1.0×10⁻⁶ (cm/s) supposing that ρ is 1.6 (g/cm³), ρw is solvent density of 1.04 (g/cm³), R is 1.0×10⁻⁵ (cm), and 11 is 0.003 (Pa·s). In addition, since the specific gravity of titanium dioxide is 4.3 (g/cm³), the pigment has pigment density twice or more as dense as that of the pigment in the related art.

The content (solid content conversion) of the inorganic pigment (A) is preferably equal to or more than 1% by mass and equal to or less than 20% by mass with respect to the total mass of the ink composition, and more preferably equal to or more than 5% by mass and equal to or less than 15% by mass. Since the content of the inorganic pigment (A) is equal to or more than 1% by mass, there is a tendency of being favorable in color density such as whiteness. In addition, since the content of the inorganic pigment (A) is equal to or less than 20% by mass, there is a tendency of reducing an occurrence of nozzle clogging in an ink jet recording head.

### 1.2. Inorganic Particle (B)

The ink composition according to the embodiment contains the inorganic particle (B). By adding the inorganic particle (B), it can be thought that the inorganic particle (B) is adsorbed to at least a part of the inorganic pigment (A). Then, the inorganic particle (B) functions as a spacer so that a likelihood that the inorganic pigments (A) are in a direct contact can be reduced. Accordingly, even when the inorganic pigment (A) is settled, hard caking can be suppressed and prompt redispersion can be carried out by simple agitation.

There is no limitation to the inorganic particle (B) as long as the inorganic particle can exhibit a function as a spacer, and there may be a white inorganic pigment such as precipitated calcium carbonate, heavy calcium carbonate, kaolin, talc, calcium sulfate, barium sulfate, titanium dioxide, zinc oxide, zinc sulfide, zinc carbonate, satin white, aluminum silicate, diatomite, calcium silicate, magnesium silicate, synthetic amorphous silica, colloidal silica, colloidal alumina, pseudo-boehmite, aluminum hydroxide, alumina, lithopone, zeolite, hydrolytic halloysite, magnesium carbonate, magnesium hydroxide, light calcium carbonate, or heavy calcium carbonate.

As for the inorganic particle (B), a silica particle and an alumina particle are preferable among the above examples. For example, when the silica particle is added, it can be thought that a functional group (for example, silanol group) present on the surface and a hydroxyl group of the inorganic pigment (A) are adsorbed by a hydrogen bond and further, a favorable effect as a spacer is exhibited.

However, there has been means for forming a film made of particles such as silica or alumina on the surface of titanium dioxide from the past. The means is provided to suppress photocatalytic activity by coating the surface of titanium dioxide with silica. Contrarily, in the invention, a likelihood that the inorganic pigments (A) are in a direct contact is reduced by adsorbing a small amount of silica particles onto the surface of the inorganic pigment (A) instead of coating the inorganic pigment (A) with silica. The invention is different from the related art in that silica particles are added as a spacer.

As for the silica particle, there may be a fumed silica in which silicon chloride, aluminum chloride, titanium chloride or the like reacts with hydrogen and oxygen under a vapor phase to be synthesized by a fumed method; silica in which metal alkoxide is hydrolyzed and condensed to be synthesized by a sol-gel method; and colloidal silica synthesized by an inorganic colloidal method, and one or more kinds thereof can be used. Among these particles, colloidal silica is preferable. As for the colloidal silica, it is possible to use commercially available colloidal silica and, for example, there may be Quartron PL-1, PL-3, and PL-7 manufactured by FUSO CHEMICAL CO., LTD. and Snowtex XL, ZL, UP, and PS-S manufactured by NISSAN CHEMICAL INDUSTRIES, LTD.

The alumina particle may have any shape of a rod shape, a beaded shape, and a spherical shape and it is preferable to use spherical colloidal alumina. As for the colloidal alumina, it is possible to use commercially available colloidal alumina, and, for example, there may be Alumina Sol 100 (cationic), Alumina Sol 200 (cationic), and Alumina Sol 520 (cationic) (the above all manufactured by NISSAN CHEMICAL INDUSTRIES, LTD.).

The average particle diameter (D_{B}) of the inorganic particle (B) is not particularly limited and the average particle diameter is preferably equal to or more than 10 nm and less than 200 nm, more preferably more than 25 nm and equal to or less than 200 nm, further preferably more than 25 nm and equal to or less than 120 nm, and particularly preferably equal to or more than 40 nm and equal to or less than 100 nm. When the average particle diameter (D_{B}) falls within the above range, a color tone is not changed in the ink and a function as a spacer can be effectively exhibited.

A ratio (D_{B}/D_{A}) of the average particle diameter (D_{B}) of the inorganic particle (B) to the average particle diameter (D_{A}) of the inorganic pigment (A) is preferably equal to or more than 0.05 and less than 1.0, more preferably equal to or more than 0.1 and equal to or less than 0.6, and particularly preferably equal to or more than 0.15 and equal to or less than 0.5. When the ratio (D_{B}/D_{A}) falls within the above range, the function of the inorganic particle (B) as a spacer is effectively exhibited and an effect of suppressing the hard caking and a redispersibility effect of the inorganic pigment (A) can be further improved.

The average particle diameter (D_{B}) of the inorganic pigment (B) is obtained by setting the basis of an abundance ratio to a volume basis and can be measured by a particle size distribution analyzer that works on the measurement principle of a dynamic diffractive scattering method. As for the particle size distribution analyzer, for example, there may be a “Nanotrac UPA” manufactured by NIKKISO CO., LTD. According to the particle size distribution analyzer that works on the measurement principle of a dynamic diffractive scattering method, the particle diameter distribution of the primary particle is obtained in a base made of a primary particle without forming a secondary particle, and the particle diameter distribution of the secondary particle can be obtained in a base made of the secondary particle in which the primary particles are aggregated or bonded.

For example, the shape of the inorganic particle (B) may be any of a spherical shape or a rod shape, a beaded shape in which the spherical particles continue and are bonded, and a needle shape. Among the shapes, a spherical shape or a rod shape is preferable from the viewpoint of effectively exhibiting a function as a spacer and a spherical shape is particularly preferable.

In addition, the shape of the inorganic particle (B) can be observed by a transmission electron microscope. In the invention, the “spherical shape” refers to meaning of excluding cases in which a beaded shape in which the spherical particles continue and are bonded, a rod shape, and a needle shape are observed when the particle is observed by the transmission electron microscope and is not limited to a real spherical shape and an oval shape.

The content of the inorganic pigment (B) is not particularly limited and the content is preferably equal to or more than 0.1% by mass with respect to the total mass of the ink composition, more preferably equal to or more than 0.3% by mass and equal to or less than 8% by mass, further preferably more than 0.5% by mass and equal to or less than 8% by mass, and particularly preferably more than 0.5% by mass and equal to or less than 5% by mass.

The content (solid content conversion) of the inorganic particle (B) is preferably equal to or more than 1 part by mass and equal to or less than 20 parts by mass with respect to 100 parts by mass of the inorganic pigment (A), and more preferably more than 5 parts by mass and equal to or less than 15 parts by mass. When the content of the inorganic particle (B) falls within the above range, an effect of suppressing the hard caking and a redispersibility effect of the inorganic pigment (A) can be further improved.

### 1.3. Other Components

At least one kind selected from alkane diols and glycol ethers may be added to the ink composition according to the embodiment, in addition to the above components. By adding alkane diols and glycol ethers, wettability to a surface of a recording medium to be recorded is increased and permeability of ink can be increased.

As for alkane diols, it is preferable to be 1,2-alkane diols having 4 to 8 carbon atoms such as 1,2-butanediol, 1,2-pentanediol, 1,2-hexanediol, 1,2-heptanediol, and 1,2-octanediol. Among the examples, 1,2-hexanediol, 1,2-heptanediol, and 1,2-octanediol having 6 to 8 carbon atoms are more preferable since the permeability to a recording medium is particularly high.

As for glycol ethers, for example, there may be a lower alkyl ether of polyalcohol such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. Among the examples, when triethylene glycol monobutyl ether is used, a favorable recording quality can be obtained.

The content of at least one kind selected from alkane diols and glycol ethers is preferably equal to or more than 1% by mass and equal to or less than 20% by mass with respect to the total mass of the ink composition, and more preferably equal to or more than 3% by mass and equal to or less than 10% by mass.

A dispersing agent for dispersing the inorganic pigment (A) may be added to the ink composition according to the embodiment, in addition to the above components. As for the dispersing agent, a dispersing agent usable in a normal pigment ink can be used without particular limitation and, for example, cationic dispersing agents, anionic dispersing agents, and non-ionic dispersing agents and surfactants can be used. Examples of anionic dispersing agents include polyacrylic acid, poly methacrylic acid, acrylic acid-acrylonitrile copolymer, vinylacetate-acrylic acid ester copolymer, acrylic acid-alkyl acrylate ester copolymer, styrene-acrylic acid copolymer, styrene-methacrylic acid copolymer, styrene-acrylic acid-alkyl acrylate ester copolymer, styrene-methacrylic acid-alkyl acrylate ester copolymer, styrene-α-methylstyrene-acrylic acid copolymer, styrene-α-methylstyrene-acrylic acid-alkyl acrylate ester copolymer, styrene-maleic acid copolymer, vinylnaphthalene-maleic acid copolymer, vinylacetate-ethylene copolymer, vinylacetate-fatty acid vinylethylene copolymer, vinylacetate-maleic acid ester copolymer, vinylacetate-crotonic acid copolymer, and vinylacetate-acrylic acid copolymer and the like. Examples of nonionic dispersing agents include polyvinyl pyrrolidone, polypropylene glycol, and vinylpyrrolidone-vinylacetate copolymer, and the like. Examples of surfactants as dispersing agents include anionic surfactants such as sodium dodecylbenzene sulfonate, sodium laurate, and ammonium salts of polyoxyethylene alkyl ether sulfate; and nonionic surfactants such as polyoxyethylene alkyl ether, polyoxyethylene alkyl ester, polyoxyethylene sorbitan fatty acid ester, polyoxyethylene alkylphenyl ether, polyoxyethylene alkylamine, and polyoxyethylene alkylamide, and the like. Among the examples, the use of styrene-(meth)acrylic acid copolymer is preferable from the viewpoint of increasing pigment dispersion stability of the inorganic pigment (A) without thickening the settlings of the inorganic pigment (A).

Acetylenic glycol surfactant or a polysiloxane surfactant may be added to the ink composition according to the embodiment in addition to the above components. By adding acetylenic glycol-based surfactant and/or polysiloxane-based surfactant, wettability to a surface of a recording medium to be recorded is increased and permeability of ink can be increased.

As for the acetylenic glycol surfactant, for example, there may be 2,4,7,9-tetramethyl-5-decyn-4,7-diol, 3,6-dimethyl-4-octyn-3,6-diol, 3,5-dimethyl-1-hexyn-3-ol, and 2,4-dimethyl-5-hexyn-3-ol. In addition, commercially available products may also be used as the acetylene glycol surfactant. For example, there can be Olfine E1010, STG, and Y (trade names, manufactured by Nissin Chemical Industry Co., Ltd.), Surfynol 104, 82, 465, 485, and TG (trade names, manufactured by Air Products and Chemicals Inc.).

Commercially available products can also be used as the polysiloxane surfactant and, for example, there may be BYK-347 and BYK-348 (trade names, manufactured by BYK Japan KK).

Furthermore, other surfactants may be added to the ink composition according to the embodiment, other than the anionic surfactant, the nonionic surfactant, and the amphoteric surfactant.

The content of the surfactant above exemplified is preferably equal to or more than 0.01% by mass and equal to or less than 5% by mass with respect to the total mass of the ink composition, and more preferably equal to or more than 0.1% by mass and equal to or less than 1% by mass.

Polyalcohol may be added to the ink composition according to the embodiment, in addition to the above components. Polyalcohol prevents the ink from drying and an occurrence of clogging of the ink can be prevented in an ink jet type recording head.

As for the polyalcohol, for example, there may be ethylene glycol, diethylene glycol, triethylene glycol, polyethylene glycol, polypropylene glycol, propylene glycol, butylene glycol, 1,2,6-hexanetriol, hexylene glycol, glycerin, trimethylolethane, and trimethylolpropane.

The content of polyalcohol is preferably equal to or more than 0.1% by mass and equal to or less than 30% by mass with respect to the total mass of the ink composition, and more preferably equal to or more than 0.5% by mass and equal to or less than 20% by mass.

A pH adjuster, an antiseptic and an antifungal agent may be added to the ink composition according to the embodiment, in addition to the above components.

As for the pH adjuster, for example, there may be potassium dihydrogen phosphate, disodium hydrogen phosphate, and sodium hydroxide, lithium hydroxide, potassium hydroxide, ammonia, diethanolamine, triethanolamine, tripropanolamine, potassium carbonate, sodium carbonate, and sodium hydrogen carbonate.

As for the antiseptic and the antifungal agent, for example, there may be sodium benzoate, sodium pentachlorophenol, 2-pyridinethiol-1-sodium oxide, sorbic acid sodium, sodium dehydroacetate, and 1,2-benzisothiazoline-3-one. As commercially available products, there may be Proxel XL2 and Proxel GXL (trade names, manufactured by NITTO DENKO Avecia Inc.) and Denicide CSA and Denicide NS-500 W (trade names, manufactured by Nagase ChemteX Corporation).

In the ink composition according to the embodiment, a main solvent (a solvent which is most largely contained with respect to the total mass of the ink composition) may be water or an organic solvent (for example, alcohols, ketones, carboxylic esters and ethers). However, water is preferable. Since the ink composition in which the main solvent is water (hereafter, referred to as an “aqueous ink”) has low reactivity with a piezoelectric element used in a recording head and an organic binder included in a recording medium in comparison with an ink composition in which the main solvent is an organic solvent (hereafter, referred to as a “nonaqueous ink”), there is almost no problem of dissolving or eroding the piezoelectric element or the organic binder. In addition, when the used solvent has a high boiling point and low viscosity in the nonaqueous ink, a problem of a considerably long drying time arises. Furthermore, since a bad odor is suppressed in the aqueous ink in comparison with the nonaqueous ink and the main solvent is water, there is an advantage that the aqueous ink is environmentally friendly. In addition, as for the water, there may be ion-exchanged water, reverse osmosis water, distilled water, and ultra-filtrated water, and the content of the water is preferably equal to or more than 50% by mass and less than 97% by mass.

The ink composition according to the embodiment can be prepared using a well-known apparatus, for example, a ball mill, a sand mill, an attritor, a basket mill, or a roll mill as pigment inks in the related art. In the preparation, coarse particles are preferably removed by using a membrane filter or a mesh filter.

### 1.4. Properties

The ink composition according to the embodiment preferably has a surface tension of 20 mN/m to 50 mN/m and more preferably equal to or more than 25 mN/m and equal to or less than 40 mN/m at 20° C., from the viewpoint of the balance between the recording quality and the reliability of an ink for ink jet. The surface tension thereof can be measured in such a manner that the ink is applied to a platinum plate to check the surface tension at 20° C. using an automatic surface tensiometer CBVP-Z (manufactured by Kyowa Interface Science Co., Ltd.).

From the same viewpoint, the ink composition according to the embodiment preferably has a viscosity of equal to or more than 2 mPa·s and equal to or less than 15 mPa·s, and more preferably equal to or more than 2 mPa·s and equal to or less than 10 mPa·s at 20° C. The viscosity thereof can be measured in such a manner that the shear rate thereof is increased from 10 to 1000 at 20° C., using a rheometer MCR-300 (manufactured by Anton Paar) and the viscosity is read at a shear rate of 200.

The pH of the ink composition according to the embodiment is preferably more than 7.0 and equal to or less than 10.0, and more preferably equal to or more than 8.0 and equal to or less than 9.5 at 25° C. When the inorganic particle (B) is a silica particle, the pH falls within the above range so that the silica particle is stable. Therefore, the aggregation of the silica particles can be reduced. Accordingly, since the number of silica particles adsorbed onto the surface of the inorganic pigment (A) can be increased, an effect of suppressing hard caking and a redispersibility effect can be further improved.

### 2. RECORDED MATTER

The invention can provide recorded matter in which an image is recorded with the above-described ink jet recording ink composition. In the above-described ink jet recording ink composition, even when the inorganic pigment (A) is settled, hard caking can be suppressed and the inorganic pigment (A) can be promptly redispersed by simple agitation. Therefore, according to the recorded matter of the invention, it is possible to obtain recorded matter in which an image is stably recorded without unevenness in print quality at any time.

### 3. EXAMPLES

The invention is further described below in detail with reference to examples. The invention is not limited to the examples.

3.1. Preparation of Ink Composition

After each component having a blending amount shown in Table was mixed and agitated, filtration was carried out by a metallic filter having a pore diameter of 5 μm and a deodorizing treatment was carried out using a vacuum pump. Then, ink compositions according to Examples 1 to 7 and Comparative Examples 1 and 2 were obtained. The unit of concentration described in Table is % by mass, and solid content conversion density with respect to both a titanium dioxide particle and a styrene acrylic resin.

The components used in Table are as follows. The particle diameter of both a titanium dioxide particle A and a titanium dioxide particle B are controlled such that grinding is carried out by a ball mill while proper conditions are changed, using TIPAQUE CR-50 manufactured by ISHIHARA SANGYO KAISHA, LTD.

### Inorganic Pigment (A)

Titanium dioxide particle A: trade name “TIPAQUE CR-50” manufactured by ISHIHARA SANGYO KAISHA, LTD., average particle diameter 280 nm

Titanium dioxide particle B: trade name “TIPAQUE CR-50” manufactured by ISHIHARA SANGYO KAISHA, LTD., average particle diameter 330 nm

The average particle diameter of the titanium dioxide particle A and the titanium dioxide particle B was measured using “Microtrac UPA” manufactured by NIKKISO CO., LTD.

### Inorganic Particle (B)

Snowtex XL: trade name, manufactured by NISSAN CHEMICAL INDUSTRIES, LTD., sphericalcolloidal silica, average particle diameter 40 to 60 nm

Snowtex ZL: trade name, manufactured by NISSAN CHEMICAL INDUSTRIES, LTD., sphericalcolloidal silica, average particle diameter 70 to 100 nm

Snowtex UP: trade name, manufactured by NISSAN CHEMICAL INDUSTRIES, LTD., rod-like colloidal silica, average particle diameter 40 to 100 nm

Snowtex PS-S: trade name, manufactured by NISSAN CHEMICAL INDUSTRIES, LTD., beaded colloidal silica, average particle diameter 80 to 120 nm (in which spherical particles of 10 to 18 nm are bonded)

The average particle diameter of the inorganic particle (B) was measured using “Nanotrac UPA” manufactured by NIKKISO CO., LTD. In addition, the shape of the inorganic particle (B) was specified by being observed using a transmission electron microscope.

### Resin

Styrene acrylic resin: trade name “YS-1274”, manufactured by SEIKO PMC CORPORATION, resin for pigment dispersion, liquid type of styrene-acrylic acid copolymer Surfactant

BYK-348: trade name, manufactured by BYK Japan KK, polysiloxane surfactant

### Others

1,2-hexanediol: penetrating agent

Propylene glycol: polyalcohol

Triethanolamine: pH adjuster

Water: ion exchanged water

When titanium dioxide was added, titanium dioxide dispersion was prepared according to the following method and added. First, 25 parts by mass of a solid acrylic acid/n-butyl acrylate/benzyl methacrylate/styrene copolymer with a glass transition temperature of 40° C., a mass average molecular weight of 10,000 and an acid value of 150 mg KOH/g was dissolved in a mixed solution of 75 parts by mass of diethylene glycol diethyl ether to obtain a polymer dispersant solution with a resin solid content of 25% by mass.

Next, 19 parts by mass of diethylene glycol diethyl ether was added to 36 parts by mass of the obtained polymer dispersant solution and mixed to prepare a resin varnish for dispersing titanium dioxide, further, 45 parts by mass of titanium dioxide was added, followed by agitating and mixing, and then kneading was carried out with a wet circulation mill to obtain the titanium dioxide dispersion.

### 3.2. Redispersibility Evaluation

100 mL of each ink composition prepared above was placed in a 100 mL screw cap bottle (manufactured by AS ONE Corporation) and was left under the environment of room temperature of 25° C. and humidity of 50% RH for six months. Then, after the left screw cap bottle was shaken up and down 10 times in a width of 30 cm, 3 mL of the top clear layer of the ink in the screw cap bottle was acquired.

Distilled water was added to 1 g of an acquired sample of each ink composition obtained as described above to obtain a 1000-fold diluted solution. Then, absorbance (Abs value) in a wavelength of 500 nm of the diluted sample was measured using a spectrophotometer U-3300 (manufactured by Hitachi Ltd.). The absorbance of each sample thus obtained was compared with the absorbance in which samples obtained by diluting the ink compositions immediately after the preparation in the same manner were measured to obtain a recovery ratio of the absorbance using the following Equation (1).

Recovery ratio of absorbance (%)=100×(absorbance of each sample/absorbance immediately after preparation). (1)

In addition, the obtained results were evaluated using the following criteria.

A: A recovery ratio is equal to or more than 90%
B: A recovery ratio is equal to or more than 80% and less than 90%
C: A recovery ratio is equal to or more than 70% and less than 80%
D: A recovery ratio is less than 70%

TABLE

| | | | | | | | | | Comparative | Comparative |
|---|---|---|---|---|---|---|---|---|---|---|
| Composition of ink composition | | Example 1 | Example 2 | Example 3 | Example 4 | Example 5 | Example 6 | Example 7 | Example 1 | Example 2 |
| Inorganic | Titanium dioxide | 10 | 10 | 10 | 10 | | | | 10 | |
| pigment (A) | particle A (% by mass) | | | | | | | | | |
| | Titanium dioxide | | | | | 10 | 10 | 10 | | 10 |
| | particle B (% by mass) | | | | | | | | | |
| Inorganic | Snowtex XL | 1 | | | | 1 | | | | |
| particle (B) | (% by mass) | | | | | | | | | |
| | Snowtex ZL | | 1 | | | | 1 | | | |
| | (% by mass) | | | | | | | | | |
| | Snowtex UP | | | 1 | | | | 1 | | |
| | (% by mass) | | | | | | | | | |
| | Snowtex PS-S | | | | 1 | | | | | |
| | (% by mass) | | | | | | | | | |
| Resin | Styrene acrylic resin | 5 | 5 | 5 | 5 | 5 | 5 | 5 | 5 | 5 |
| | (% by mass) | | | | | | | | | |
| Surfactant | BYK-348 (% by mass) | 0.5 | 0.5 | 0.5 | 0.5 | 0.5 | 0.5 | 0.5 | 0.5 | 0.5 |
| Others | 1,2-hexanediol | 5 | 5 | 5 | 5 | 5 | 5 | 5 | 5 | 5 |
| | (% by mass) | | | | | | | | | |
| | Propylene glycol | 13 | 13 | 13 | 13 | 13 | 13 | 13 | 13 | 13 |
| | (% by mass) | | | | | | | | | |
| | Triethanolamine | 0.8 | 0.8 | 0.8 | 0.8 | 0.8 | 0.8 | 0.8 | 0.8 | 0.8 |
| | (% by mass) | | | | | | | | | |
| | Water (% by mass) | Residue | Residue | Residue | Residue | Residue | Residue | Residue | Residue | Residue |
| Total (% by mass) | | 100 | 100 | 100 | 100 | 100 | 100 | 100 | 100 | 100 |
| pH (at 25° C.) | | 8.8 | 8.8 | 8.8 | 8.8 | 8.8 | 8.8 | 8.8 | 8.8 | 8.8 |
| Redispersion | Recovery ratio of | 95 | 98 | 95 | 72 | 91 | 95 | 88 | 55 | 42 |
| evaluation | absorbance (%) | | | | | | | | | |
| | Determination result | A | A | A | C | A | A | B | D | D |

### 3.3. Evaluation Results

According to the results shown in Table, the absorbance of the recovery ratio is considerably increased in Examples 1 to 7 in which the silica particle is added, in comparison with Comparative Examples 1 and 2 in which the silica particle is not added. In addition, according to the results shown in Table, when the silica particle having a spherical shape and an average particle diameter of 40 to 100 nm is added, the absorbance of the recovery ratio is particularly excellent.

From the above results, in the ink jet recording ink composition according to the invention, even when the inorganic pigment is settled, hard caking can be suppressed and the inorganic pigment can be promptly redispersed by simple agitation.

The invention is not limited to the above-described embodiments and further, various modifications can be made. For example, the invention includes substantially the same configuration (for example, a configuration which has the same function, method, and results or a configuration which has the same object and effect) as the configuration described in the embodiments. Further, the invention includes a configuration which replaces a non-essential section of the configuration described in the embodiments. Further, the invention includes a configuration which has the same operation advantage as the configuration described in the embodiments or a configuration which can accomplish the same object. Further, the invention includes a configuration in which a well-known technology is added to the configuration described in the embodiments.

What is claimed is:

1. An ink jet recording ink composition comprising:
an inorganic pigment (A) having an average particle diameter (D_{A}) of equal to or more than 200 nm; and
an inorganic particle (B).

2. The ink jet recording ink composition according to claim 1,
wherein the inorganic particle (B) is a silica particle or an alumina particle.

3. The ink jet recording ink composition according to claim 1,
wherein an average particle diameter (D_{B}) of the inorganic particle (B) measured using a dynamic light scattering method is more than 25 nm and equal to or less than 200 nm.

4. The ink jet recording ink composition according to claim 1,
wherein a settling rate calculated by Stokes' equation in the ink jet recording ink composition of the inorganic pigment (A) is equal to or more than 2.5×10⁻⁶ (cm/s).

5. The ink jet recording ink composition according to claim 1,
wherein a content (solid content conversion) of the inorganic pigment (A) is equal to or more than 5% by mass and equal to or less than 15% by mass with respect to a total mass of the ink composition, and
a content (solid content conversion) of the inorganic particle (B) is more than 0.5% by mass and equal to or less than 8% by mass with respect to the total mass of the ink composition.

6. The ink jet recording ink composition according to claim 1,
wherein a ratio (D_{B}/D_{A}) of the average particle diameter (D_{B}) of the inorganic particle (B) to the average particle diameter (D_{A}) of the inorganic pigment (A) is equal to or more than 0.05 and less than 1.0.

7. The ink jet recording ink composition according to claim 1,
wherein the pH is more than 7 and equal to or less than 10 at 25° C.

8. Recorded matter in which an image is recorded with the ink jet recording ink composition according to claim 1.

9. Recorded matter in which an image is recorded with the ink jet recording ink composition according to claim 2.

10. Recorded matter in which an image is recorded with the ink jet recording ink composition according to claim 3.

11. Recorded matter in which an image is recorded with the ink jet recording ink composition according to claim 4.

12. Recorded matter in which an image is recorded with the ink jet recording ink composition according to claim 5.

13. Recorded matter in which an image is recorded with the ink jet recording ink composition according to claim 6.

14. Recorded matter in which an image is recorded with the ink jet recording ink composition according to claim 7.
